(19) United States
(12) Patent Application Publication
(10) Pub. No.: US 2026/0342368 A1
(43) Pub. Date: Oct. 29, 2026

(54) ADAPTIVE ANTENNA MATCHING TUNING

(71) Applicant: Telefonaktiebolaget LM Ericsson (publ), Stockholm (SE)

(72) Inventors: Hamed FARHADI, Stockholm (SE); Lars SUNDSTRÖM, Lund (SE)

(21) Appl. No.: 19/119,639

(22) PCT Filed: Oct. 20, 2022
(86) PCT No.: PCT/SE2022/050951

§ 371 Date: Apr. 9, 2025

(51) Int. Cl. H04B 1/04; H01Q 5/335

(52) U.S. Cl. CPC H04B 1/0458; H01Q 5/335

(57) ABSTRACT

A method, system and apparatus for adaptive antenna matching tuning are disclosed. In some embodiments, a method in a wireless device (WD) configured with impedance matching circuitry includes determining WD contextual information, the contextual information including environmental information and/or hardware operating conditions of the WD. The method also include determining at least one prediction of at least one of the antenna element input impedance, the power amplifier output impedance and a set of at least one control parameter of the impedance matching circuitry based at least in part on the WD contextual information. The process includes performing an adjustment to the impedance matching circuitry based at least in part on the at least one prediction.

### TECHNICAL FIELD

The present disclosure relates to wireless communications, and in particular, to a method for adaptive antenna matching tuning.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### Impedance Matching:

Power transfer from a first device (e.g., a power amplifier, PA) to a second device or load (e.g., an antenna) in an electrical system is not usually perfect and is subject to some signal reflections. The signal reflection degrades the power transfer from an electrical device to a load. The amount of signal reflections depends at least in part on the output impedance of the first device and the input impedance of the second device. Impedance matching refers to designing or adjusting the input or output impedance of an electrical device to a desired value, where the desired value is selected to maximize power transfer or minimize signal reflection. For example, impedance matching can be performed to maximize power transfer from a power amplifier to an antenna of a radio transmitter. Complex conjugate matching can be used to maximize power transfer, namely:

Z_{PA}=Zₐₙₜₑₙₙₐ^{*},
where Z_{PA} is the PA's output impedance and Zₐₙₜₑₙₙₐ^{*} is the antenna's input impedance.

Complex conjugate matching is sometimes also referred to as gain matching as it maximizes the power gain of the first device, from an output of the first device to an input of the second device, or antenna. However, in some cases there are additional constraints to account for, e.g., a maximum voltage swing at the output defined by the supply voltage, or even reliability constraints to avoid device breakdown. Hence, when the aim is to maximize the absolute power level rather than the gain, the optimum impedance may not coincide with the complex conjugate of the PA's output impedance. This is sometimes referred to as power match and can yield a few dB higher maximum output power at the expense of lowered gain. From here on impedance matching refers to any type of impedance matching between first device and its load (antenna) with respect to a set of objectives.

There are several well established techniques for impedance matching including using transformers, networks of lumped resistance, capacitance and inductance, properly proportioned transmission lines, or some combination of these.

The impedance matching is sensitive to different operating conditions (e.g., the frequency of operation) and the changes in the surrounding environment of the devices.

Antenna Impedance Variation with User Proximity:

The antenna impedance variations of a mobile phone when the user interacts with the mobile has been measured and the results for antenna impedance variations in proximity of the user of the device are known. It has been shown that the antenna impedance varies considerably due to user interactions. For instance, it has been shown that the antenna's impedance becomes more resistive and inductive as the level of user interaction increases. It has also been shown that the level of impedance mismatch sharply increases when a part of the hand or finger touches the surface area directly above part of the antenna. Also, the antennas have low efficiency in the presence of the user which calls for further improvement.

Antenna Impedance Variation with Temperature:

The impact of temperature variations on the antenna impedance of a rectangular patch antenna has been investigated. It has been shown that the temperature may impact the antenna's input impedance. It has been shown that when the temperature is decreased, the value of impedance reduces and reflected loss of the antenna increases.

Power Amplifier Output Impedance Variation with Temperature:

It is well known that many parameters of power amplifier devices vary with temperature that in turn translate into temperature dependent output impedance and gain, the former affecting the efficiency in power transfer as it may lead to deviation from the targeted impedance matching. Some of these device parameters have been explored and modelled. Further variation may be introduced by support circuitry for the power amplifier, responsible for maintaining, e.g., bias voltages and currents.

### Tunable Matching Circuit:

Reconfigurable tuners that utilize electrostatically activated microelectromechanical systems (MEMS) switches in a series configuration has been proposed. The tuner can match a wide variety of loads for frequencies ranging from 10 to 20 GHz. It includes a digital capacitor bank, where each bank has a predetermined number of capacitors. The activation of appropriate MEMS switches can set the number of capacitors which are dictated by the range of loads that needs to be matched. Alternatively, varactors or PIN diode-based switching can be used for a matching circuit.

Adaptive impedance matching systems have been proposed. These methods require an analog reflection measurement circuit and using a test signal to adapt the settings of the matching circuit.

A method and system for detecting whether the position of a user's hand gripping a mobile communication device chassis affects an external antenna has also been studied.

### Machine Learning:

Machine learning refers to a class of techniques in which a model is trained based on data and is used for applications such as classification and regression. The training of the models can be performed using either supervised methods, where for a given input data the intended outputs are available or using unsupervised data where no labeled data is required for training the models.

Artificial Neural Networks: artificial neural networks are a class of machine learning algorithms that are widely used due to their capability to approximate any general function based on sample data sets, and their inherent parallel processing which make these techniques attractive candidates for implementation on emerging artificial intelligence (AI) accelerator hardware. A neural network is based on interconnected processing units called neurons as depicted in FIG. 1, where each neuron receives a weighted version of the output of another neuron from the previous layer and computes the output based on a nonlinear transformation of the aggregated inputs. In FIG. 1, each neuron in a layer is represented by a circle. The network is composed of L layers, where the l'th layer has N^{l} neurons. The number of neurons in different layers can be different. As a special case, the number of neurons in two or more layers can be the same. Each neuron is a processing unit, and the output of the n'th neuron in the l'th layer of the network is denoted as xₙ^{l} which is computed based on the output of the neurons in the previous layer as follows:

$${x}_{n}^{l} = f ( {\sum }_{j = 1}^{{N}^{l - 1}} ( {x}_{j}^{l - 1} \times {w}_{j , n}^{l - 1} ) + {b}_{n}^{l} )$$

where

$${w}_{j , n}^{l - 1}$$

is the weight corresponding to the connection between the jth neuron in layer l−1 and the nth neuron in layer l, and

$${b}_{n}^{l}$$

denotes the bias value corresponding to the nth neuron in layer l. The function f(.) is a nonlinear function. The total number of neurons in a network is

$$N = {\sum }_{l = 1}^{L} {N}^{l} .$$

The processing within neurons in each layer can be performed in parallel. Therefore, neurons within the same layer (e.g., L−1) typically transmit output signals to the next layer (e.g., L) at or around the same time. In this network, layer 1 is usually referred to as the input layer, layer L is referred to as the output layer, and the layers between these two layers are referred to as hidden layers. A neural network can be trained by adjusting the weight and bias values so that the desired mapping between the inputs to the input layer and the outputs from the output layer can be realized. The number of neurons in the input layer is specified by the number of input variables, and the number of neurons in the output layer are specified by the number of output variables of the function to be approximated by the neural network.

### SUMMARY

Some embodiments advantageously provide methods, and wireless device for adaptive antenna matching tuning.

Power efficiency of a WD transmitter is impacted by the amount of available output power from WD's power amplifier (PA) that can be delivered to the WD's antenna. This depends on the matching between the antenna's input impedance and the PA's output impedance. The antenna input impedance and PA's output impedance are not fixed in general and are impacted by the surrounding environment of the WD and the user proximity. The mismatch between PA and antenna due to the variations in the WD's surrounding environment lowers the delivered power to the antenna and reduces the WD's power efficiency.

Adaptive impedance matching systems have been proposed. However, these methods require extra hardware for reflection measurements and test signals to adapt the settings of the matching circuit. These methods have relatively higher complexity and cost.

A method and system for detecting whether the position of a user's hand gripping a mobile communication device chassis affects an external antenna has been provided.

Some embodiments address the impact that the PA, antenna impedance and environmental factors such as temperature have on power amplifier output impedance and antenna input impedance. In some embodiments, power efficiency of a wireless device (WD) is enhanced by obtaining contextual information from the surrounding environment of the WD from the embedded sensors, and predicting the antenna's input impedance and the PA's output impedance. Some embodiments, include computing the setting of a matching circuit based on the trained models and the obtained contextual information. The parameters of the impedance matching circuit between the power amplifier and the antenna may be tuned to optimize an objective function, e.g., to maximize the power delivered to the antenna or to minimize the reflected power from the antenna.

In some embodiments, power efficiency of a WD is enhanced by obtaining information from the environment of the WD and the operating information of the WD, and predicting the antenna's input impedance and the PA's output impedance using the obtained environmental information. In some embodiments the parameters of the impedance matching circuit between the power amplifier and the antenna are tuned to achieve an objective, e.g., to maximize the delivered absolute power to the antenna (power matching), maximize the PA gain (gain matching), minimize the reflected power from the antenna (gain matching), or maximize the power efficiency of the PA.

The contextual information includes environmental information about the WD's surrounding environment. For example, the position of fingers on/around the WD, or information about whether the WD is beside the user's head and the distance to the user's head, or whether it is near metal/dielectric objects and the distance to the object, or the temperature/humidity of the environment. It is readily understood that the sensors may provide measurements indicative of said WD surroundings rather than a direct representation of, say, location of fingers, head etc. For example, a sensor may provide an indication of the distance to an object and the material properties of an object. Depending on type, location, and number of sensors, the composite set of sensor outputs will provide and more or less accurate and indirect representation of WD's surrounding environment.

The contextual information can be obtained using embedded sensors in the WD, e.g., capacitive/resistive touch screens (e.g., to find finger position on the screen), accelerometer, thermometers, humidity sensors, magnetometers (e.g., to find the distance to metal objects), proximity sensors (e.g., to estimate the distance to head).

The operating information of the WD includes information about the operating conditions of the WD's hardware. For example, the Radio Frequency (RF) frequency of operation, the PA back-off level, the PA temperature, the PA's bias current and/or voltage levels, the PA's temperature, ambient temperature, WD power consumption, and parameters from associated PA manufacturing batch.

The antenna's input impedance and PA's output impedance can be predicted as a function of the measured contextual information from the sensors using, e.g., a machine learning technique such as an artificial neural network which trains a model based on a set of observations (e.g., measurements from the sensors and the acquired operating information) and labels (measured antenna and PA impedances).

If the impedance mismatch between the predicted impedance and the impedance of the matching circuit is larger than a threshold, then the impedance matching circuit may be tuned according to the predicted load (antenna) impedance and source (PA) impedance. The parameters of a tunable impedance matching circuit may be set to achieve an objective, e.g., maximize power transfer to the antenna or minimize reflected power from the antenna. The impedance mismatch, and the associated threshold, can be represented in several ways including the complex-valued difference between the actual and the desired impedance, the voltage-standing-wave ratio (VSWR) associated with the predicted impedance (with the desired impedance as reference). It is readily understood that the mismatch can be represented in many different ways.

In another embodiment, a method is provided to enhance power efficiency of a WD by obtaining contextual information from environment of the WD and operating information of the WD, and predicting parameter settings of the impedance matching circuit to achieve an objective, e.g., to maximize the delivered power to the antenna or minimize the reflected power from the antenna, and tuning the parameters of the impedance matching circuit between the power amplifier and the antenna.

The parameter settings of the impedance matching circuit are predicted using a trained model so that an objective such as the amount of the reflected power from the antenna being minimized or the amount of the delivered power to the antenna being maximized using e.g., a machine learning technique such as an artificial neural network to train a model based on a set of observations (e.g., measurements from sensors) and labels (e.g., measured reflection).

If the mismatch between the predicted parameters and the parameters of the matching circuit is larger than a threshold, then the parameter of the matching circuit may be tuned.

According to one aspect, a method in a wireless device, WD, configured with impedance matching circuitry and processing circuitry in communication with the impedance matching circuitry is provided. The processing circuitry is configured to control the impedance matching circuitry to compensate for a difference between an output impedance of a power amplifier and an input impedance of an antenna element. The method includes determining WD contextual information, the contextual information including at least one of environmental information and hardware operating conditions of the WD. The method also includes determining at least one prediction of at least one of the antenna element input impedance, the power amplifier output impedance and a set of at least one control parameter of the impedance matching circuitry based at least in part on the contextual information. The method further includes performing an adjustment to the impedance matching circuitry based at least in part on the at least one prediction.

According to this aspect, in some embodiments, the at least one prediction is obtained from a neural network trained to minimize a loss function, the loss function based at least in part on a difference between an expected value and a resultant value. In some embodiments, determining the at least one prediction includes determining a prediction expected to reduce an amount of power reflected backward from an input of the antenna element toward an output of the power amplifier. In some embodiments, determining the at least one prediction includes determining a prediction expected to increase an amount of power transferred by the impedance matching circuit from an output of the power amplifier to an input of the antenna element. In some embodiments, determining the at least one prediction includes determining a prediction expected to increase a gain of the power amplifier. In some embodiments, determining the at least one prediction includes determining a prediction expected to increase a power efficiency of the power amplifier. In some embodiments, the environmental information includes sensor information from embedded sensors configured to detect a relative position of the WD. In some embodiments, the relative position of the WD includes at least one of a position of fingers in proximity to the WD, a position of the WD with respect to a user's head, and a position of the WD relative to a material object. In some embodiments, the hardware operating conditions include at least one of a power amplifier temperature, backoff level, biasing level and impedances. In some embodiments, the at least one control parameter is based at least in part on a whether an impedance mismatch between the output impedance of the power amplifier and an input impedance of the antenna element exceeds a threshold. In some embodiments, the impedance mismatch is determined based at least in part on at least one of an impedance difference and a voltage standing wave ratio, VSWR.

According to another aspect, a WD includes impedance matching circuitry configured to compensate for a difference between an output impedance of a power amplifier of the WD and an input impedance of an antenna element of the WD. The WD also includes processing circuitry in communication with the impedance matching circuitry and configured to: determine WD contextual information, the WD contextual information including at least one of environmental information and hardware operating conditions of the WD; and determine at least one prediction of at least one of the antenna element input impedance, the power amplifier output impedance and a set of at least one control parameter of the impedance matching circuitry based at least in part on the contextual information. The processing circuitry is further configured to perform an adjustment to the impedance matching circuitry based at least in part on the at least one prediction.

According to this aspect, in some embodiments, the at least one prediction is obtained from a neural network trained to minimize a loss function, the loss function based at least in part on a difference between an expected value and a resultant value. In some embodiments, determining the at least one prediction includes determining a prediction expected to reduce an amount of power reflected backward from an input of the antenna element toward an output of the power amplifier. In some embodiments, determining the at least one prediction includes determining a prediction expected to increase an amount of power transferred by the impedance matching circuit from an output of the power amplifier to an input of the antenna element. In some embodiments, determining the at least one prediction includes determining a prediction expected to increase a gain of the power amplifier. In some embodiments, determining the at least one prediction includes determining a prediction expected to increase a power efficiency of the power amplifier. In some embodiments, the environmental information includes sensor information from embedded sensors configured to detect a relative position of the WD. In some embodiments, the relative position of the WD includes at least one of a position of fingers in proximity to the WD, a position of the WD with respect to a user's head, and a position of the WD relative to a material object. In some embodiments, the hardware operating conditions of the WD include at least one of a power amplifier temperature, backoff level, biasing level and impedances. In some embodiments, the at least one control parameter is based at least in part on a whether an impedance mismatch between the output impedance of the power amplifier and an input impedance of the antenna element exceeds a threshold. In some embodiments, the impedance mismatch is determined based at least in part on at least one of an impedance difference and a voltage standing wave ratio, VSWR.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a neural network;

FIG. 2 is a schematic diagram of an example network architecture illustrating a communication system according to principles disclosed herein;

FIG. 3 is a block diagram of a network node in communication with a wireless device over a wireless connection according to some embodiments of the present disclosure;

FIG. 4 is a flowchart of an example process in a wireless device for adaptive antenna matching tuning according to some embodiments of the present disclosure;

FIG. 5 is a flowchart of another example process in a wireless device for adaptive antenna matching tuning according to some embodiments of the present disclosure;

FIG. 6 is a flowchart of yet another example process in a wireless device for adaptive antenna matching tuning according to some embodiments of the present disclosure; and

FIG. 7 is a block diagram of a radio transceiver that includes an impedance matching circuit tuned by a neural network according to some embodiments of the present disclosure.

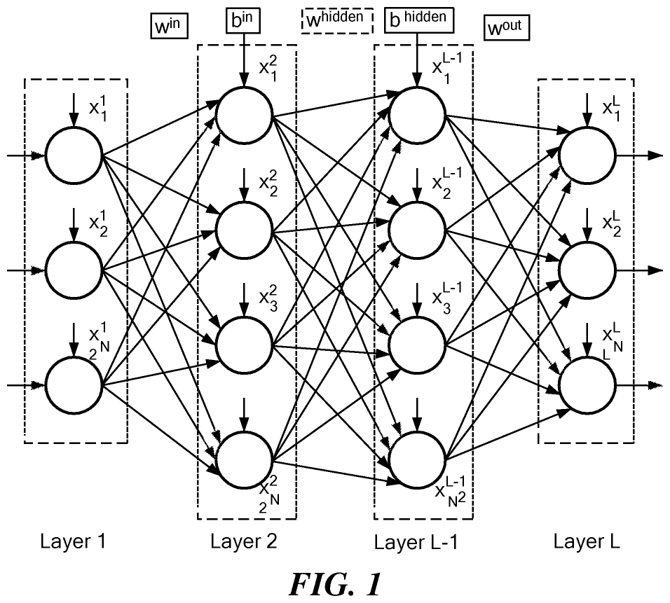

### DETAILED DESCRIPTION

Before describing in detail example embodiments, it is noted that the embodiments reside primarily in combinations of apparatus components and processing steps related to adaptive antenna matching tuning. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote an apparatus for wireless communication such as a wireless device (WD) or a radio network node.

In some embodiments, the non-limiting terms wireless device (WD) or a WD are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), BLUETOOTH and Wi-Fi may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to adaptive antenna matching tuning.

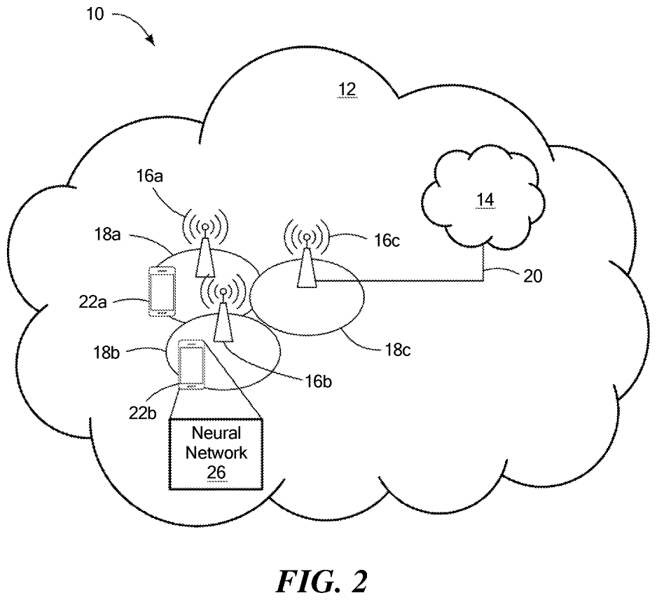

Returning to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A wireless device 22 is configured to include a neural network 26 which is configured to determine at least one prediction of at least one of the antenna element input impedance, the power amplifier output impedance and a set of at least one control parameter of the impedance matching circuitry based at least in part on the contextual information.

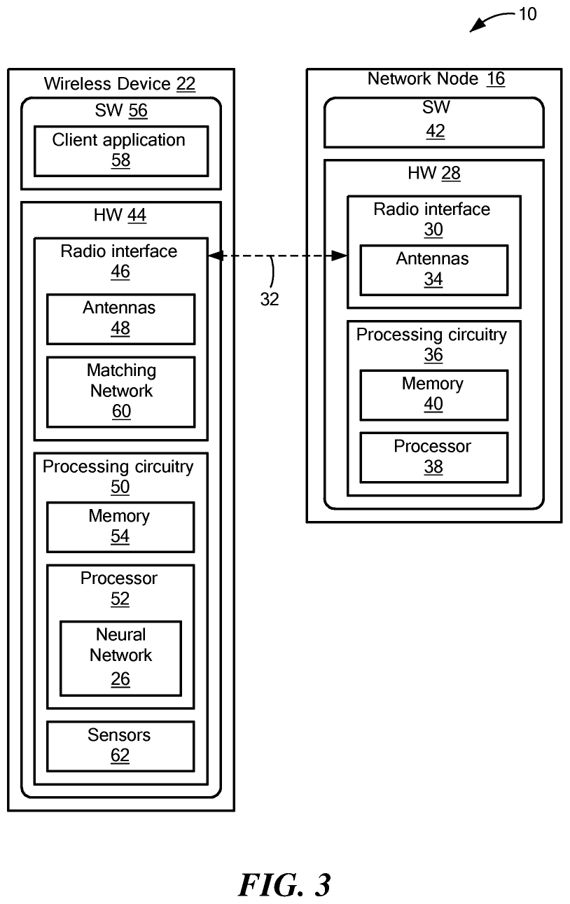

Example implementations, in accordance with an embodiment, of the WD 22 and network node 16 discussed in the preceding paragraphs will now be described with reference to FIG. 3.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16.

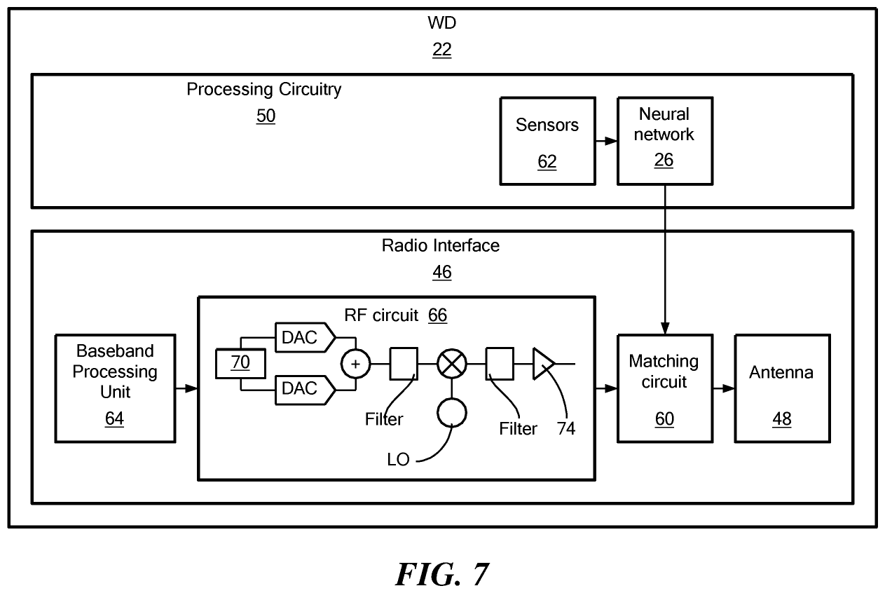

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves. the radio interface 46 is also configured to include an impedance matching circuit 60 configured to match an output impedance of a power amplifier (shown in FIG. 7) of the radio interface 46 to the input impedance of an antenna element of the antennas 48.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, program/mmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a neural network 26 which is configured to determine at least one prediction of at least one of the antenna element input impedance, the power amplifier output impedance and a set of at least one control parameter of the impedance matching circuitry 60 based at least in part on the contextual information. In some embodiments, in addition to the neural network 26, the processing circuitry may include sensors 62 and associated circuitry. The sensors 62 may be configured to sense operating conditions, such as temperature and relative position of the WD with respect to the user's head, for example.

In some embodiments, the inner workings of the network node 16 and WD 22 may be as shown in FIG. 3 and independently, the surrounding network topology may be that of FIG. 2.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 2 and 3 show various “units” such as neural network 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

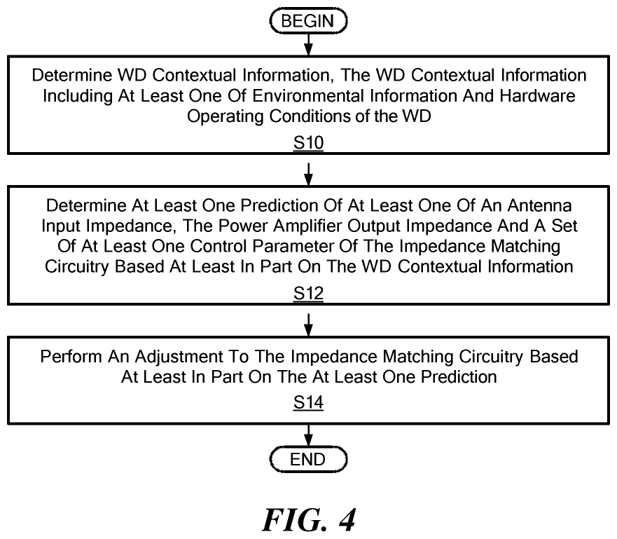

FIG. 4 is a flowchart of an example process in a wireless device 22 according to some embodiments of the present disclosure. One or more blocks described herein may be performed by one or more elements of wireless device 22 such as by one or more of processing circuitry 50 (including the neural network 26), processor 52, and/or radio interface 46. Wireless device 22 such as via processing circuitry 50 and/or processor 52 and/or radio interface 46 is configured to determine WD contextual information, the WD contextual information including at least one of environmental information and hardware operating conditions of the WD (22) (Block S10). The process also includes determining at least one prediction of at least one of the antenna element input impedance, the power amplifier 74 output impedance and a set of at least one control parameter of the impedance matching circuitry 60 based at least in part on the contextual information (Block S12). The process also includes performing an adjustment to the impedance matching circuitry 60 based at least in part on the at least one prediction (Block S14).

In some embodiments, the at least one prediction is obtained from a neural network 26 trained to minimize a loss function, the loss function based at least in part on a difference between an expected value and a resultant value. In some embodiments, determining the at least one prediction includes determining a prediction expected to reduce an amount of power reflected backward from an input of the antenna element 48 toward an output of the power amplifier 74. In some embodiments, determining the at least one prediction includes determining a prediction expected to increase an amount of power transferred by the impedance matching circuit 60 from an output of the power amplifier 74 to an input of the antenna element 48. In some embodiments, determining the at least one prediction includes determining a prediction expected to increase a gain of the power amplifier 74. In some embodiments, determining the at least one prediction includes determining a prediction expected to increase a power efficiency of the power amplifier 74. In some embodiments, the environmental information includes sensor information from embedded sensors configured to detect a relative position of the WD 22. In some embodiments, the relative position of the WD 22 includes at least one of a position of fingers in proximity to the WD 22, a position of the WD 22 with respect to a user's head, and a position of the WD 22 relative to a material object. In some embodiments, the hardware operating conditions of the WD 22 include at least one of a power amplifier 74 temperature, backoff level, biasing level and impedances. In some embodiments, the at least one control parameter is based at least in part on a whether an impedance mismatch between the output impedance of the power amplifier 74 and an input impedance of the antenna element 48 exceeds a threshold. In some embodiments, the impedance mismatch is determined based at least in part on at least one of an impedance difference and a voltage standing wave ratio, VSWR.

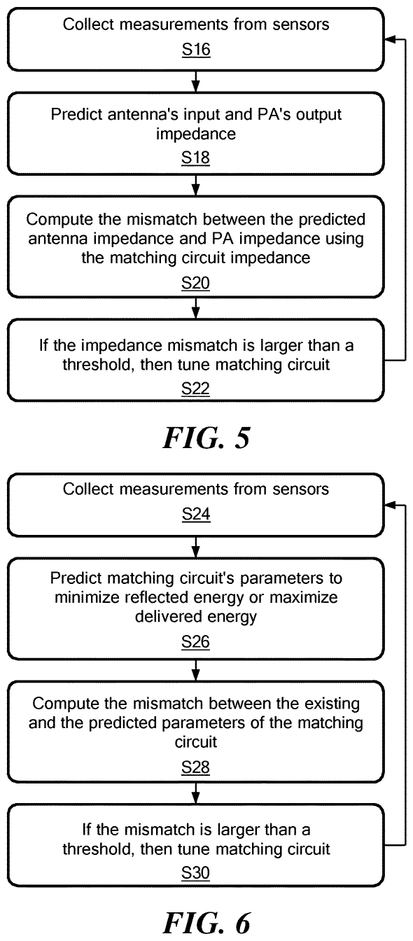

FIG. 5 is a flowchart of an example process in a wireless device 22 according to some embodiments of the present disclosure. One or more blocks described herein may be performed by one or more elements of wireless device 22 such as by one or more of processing circuitry 50 (including the neural network 26), processor 52, and/or radio interface 46. Wireless device 22 such as via processing circuitry 50 and/or processor 52 and/or radio interface 46 is configured to predict an input impedance of an antenna element 48 and an output impedance of a power amplifier 74 (Block S18). The process also includes computing the mismatch between these two impedances using the matching circuit impedance (Block S20). The process further includes tuning the matching circuit when the impedance mismatch exceeds a threshold (Block S22).

FIG. 6 is a flowchart of an example process in a wireless device 22 according to some embodiments of the present disclosure. One or more blocks described herein may be performed by one or more elements of wireless device 22 such as by one or more of processing circuitry 50 (including the neural network 26), processor 52, and/or radio interface 46. Wireless device 22 such as via processing circuitry 50 and/or processor 52 and/or radio interface 46 is configured to collect measurements from at least one sensor (Block S24). The process also includes predicting matching circuit parameters to minimize reflected energy or maximize energy delivered to the antenna 48 (Block S26). The process further includes computing the mismatch between the existing parameters and the predicted parameters of the matching circuit (Block S28). The process also include tuning the matching circuit when the impedance mismatch exceeds a threshold (Block S30).

Having described the general process flow of arrangements of the disclosure and having provided examples of hardware and software arrangements for implementing the processes and functions of the disclosure, the sections below provide details and examples of arrangements for adaptive antenna matching tuning.

### Embodiment A

In some embodiments, a method is provided to enhance power efficiency of a WD 22 by obtaining contextual information from surrounding environment of the WD 22 and the operating information of the WD 22. This information may be used to predict the antenna's input impedance and the PA's output impedance using the obtained contextual information, and tune the parameters of the impedance matching circuit between the power amplifier 74 and the antenna 48 to achieve an objective, e.g., to maximize the delivered power to the antenna 48 or minimize the reflected power from the antenna 48.

The contextual information includes information about the WD's surrounding environment. For example, the position of fingers on or around the WD 22, or information about whether the WD 22 is beside the head and the distance to the head, or whether it is near metal/dielectric objects and the distance to the object, or the temperature/humidity of the environment. The sensors may provide measurements indicative of said WD 22 surroundings rather than a direct representation of, say, location of fingers, head etc. For example, a sensor may provide an indication of distance to an object and material properties of an object. Depending on type, location, and number of sensors, the composite set of sensor outputs may provide a more or less accurate and indirect representation of the WD's surrounding environment.

The contextual information may be obtained using embedded sensors, e.g., sensors 62, in the WD 22, e.g., capacitive/resistive touch screens (e.g., to find finger position on the screen), accelerometer, thermometers, humidity sensor, magnetometer (e.g., to find the distance to metal objects), proximity sensor (e.g., to estimate the distance to head).

The operating information of the WD 22 may include information about the operating conditions of the WD's hardware. For example, operating information may include the RF frequency of operation, the PA back-off level, the PA's bias current/voltage levels, PA's temperature, ambient temperature, WD 22 power consumption, parameters from associated PA manufacturing batch indicative of various electrical component characteristics associated with said manufacturing batch.

The antenna's input impedance may be predicted as a function of the measured contextual information from the sensors using, e.g., a machine learning technique such as an artificial neural network 26.

The input of the neural network 26 is a vector with elements that are measurements from the array of sensors representing contextual information and operating information or a function of variables representing this information. The number of neurons in the input layer of the neural network 26 may be equal to the number of the elements in the measurement vector.

The output of the neural network 26 may be the predicted antenna's impedance. The output layer of the neural network 26 may be constructed of two neurons, where one of them is corresponding to the real part and the other one is corresponding to the imaginary part of the predicted impedance.

The neural network 26 may be trained offline using supervised methods by minimizing a loss function to measure the distance of the true impedance value based on impedance measurements and the predicted impedance computed by the neural network 26. The loss function may be computed over the collected training dataset using measurements, and the model parameters may be updated using methods such as gradient descent and backpropagation methods to minimize the loss function.

In known terminology for neural network training, a training dataset includes a pair of ‘features’ and corresponding ‘labels’. In the case of training a neural network for impedance prediction as used herein, the features (or observations) are inputs from sensors and the labels are the impedance values. Considering that the training phase of a neural network can be performed offline, e.g., in a lab setup, the impedance value corresponding to sensor measurements can be measured to construct the training dataset. Subsequent to the training phase, during the inference phase, the model can be deployed and no impedance measurement is needed. Alternatively, in the case of predicting reflections, the labels can be measured reflections, where the measured reflections corresponding to the sensor measurements can be collected in the lab to construct the training data set.

The impedance matching circuit may be tuned according to the predicted load impedance and predicted power amplifier output impedance by setting parameters of a tunable impedance matching circuit, e.g., the resistance, capacitance, inductance of the elements in the matching circuit e.g., to maximize power transfer to the antenna 48 or minimize reflected power from the antenna 48.

### Embodiment B

In another embodiment, a method enhances the power efficiency of a WD 22 by obtaining contextual information from the environment of the WD 22 and operating information of the WD 22, and predicting control parameters of the impedance matching circuit to maximize the delivered power to the antenna 48 or minimize the reflected power from the antenna 48. The parameters of the impedance matching circuit between the power amplifier 74 and the antenna 48 may be tuned.

The control parameters of the impedance matching circuit may be predicted so that, e.g., the amount of the reflected power from the antenna 48 may be minimized or the amount of the delivered power to the antenna 48 may be maximized using, e.g., a machine learning technique such as an artificial neural network 26.

The input of the neural network 26 is a vector with elements that may include measurements from the array of sensors representing contextual information and operating information. The number of neurons in the first layer may be equal to the number of elements in the measurement vector.

The outputs of the neural network 26 are the predicted control parameters of the impedance matching circuit.

The neural network 26 may be trained offline using supervised methods by computing the neural network 26 parameters, e.g., to minimize a loss function to measure the reflected power from the antenna 48 or to maximize a function that measures transferred power to the antenna 48.

### Example Implementation

An example implementation is illustrated in FIG. 7. In this example, a baseband unit 64 computes the digital signals to be transmitted, the RF circuit 66 modulates the signals using an I/Q modulator 70, upconverts the signal using a mixer 72, and passes the signal through a power amplifier 74. The matching circuit 60 has tunable parameters operatively connected between the power amplifier 74 and the antenna 48. The embedded sensors 62 may measure an estimate of the variables related to the surrounding area of the WD 22 and send the measurements to the neural network 26. The neural network 26 may predict the input impedance of the antenna 48 and/or the output impedance of the power amplifier and compute the parameters of the matching circuit 60 to minimize power reflection from the antenna 48. The output of the neural network 26 may be used to tune to the parameters of the matching circuit 60.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention has been made above to the contrary, it should be noted that all of the accompanying drawings are not to scale. A variety of modifications and variations are possible in light of the above teachings without departing from the scope of the following claims.

1. A method in a wireless device, WD, configured with impedance matching circuitry and processing circuitry in communication with the impedance matching circuitry and configured to control the impedance matching circuitry to compensate for a difference between an output impedance of a power amplifier and an input impedance of an antenna element, the method comprising:
determining WD contextual information, the WD contextual information including at least one of environmental information and hardware operating conditions of the WD;
determining at least one prediction of at least one of the antenna element input impedance, the power amplifier output impedance and a set of at least one control parameter of the impedance matching circuitry based at least in part on the WD contextual information; and
performing an adjustment to the impedance matching circuitry based at least in part on the at least one prediction.

2. The method of claim 1, wherein the at least one prediction is obtained from a neural network trained to minimize a loss function, the loss function based at least in part on a difference between an expected value and a resultant value.

3. The method of claim 2, wherein determining the at least one prediction includes determining a prediction expected to reduce an amount of power reflected backward from an input of the antenna element toward an output of the power amplifier.

4. The method of claim 2, wherein determining the at least one prediction includes determining a prediction expected to increase an amount of power transferred by the impedance matching circuit from an output of the power amplifier to an input of the antenna element.

5. The method of claim 2, wherein determining the at least one prediction includes determining a prediction expected to increase a gain of the power amplifier or to increase a power efficiency of the power amplifier.

6. (canceled)

7. The method of claim 1, wherein the environmental information includes sensor information from embedded sensors configured to detect a relative position of the WD.

8. The method of claim 7, wherein the relative position of the WD includes at least one of a position of fingers in proximity to the WD, a position of the WD with respect to a user's head, and a position of the WD relative to a material object.

9. The method of claim 1, wherein the hardware operating conditions of the WD include at least one of a power amplifier temperature, backoff level, biasing level and impedances.

10. The method of claim 1, wherein the at least one control parameter is based at least in part on a whether an impedance mismatch between the output impedance of the power amplifier and an input impedance of the antenna element exceeds a threshold.

11. The method of claim 10, wherein the impedance mismatch is determined based at least in part on at least one of an impedance difference and a voltage standing wave ratio, VSWR.

12. A wireless device, WD, comprising:
impedance matching circuitry configured to compensate for a difference between an output impedance of a power amplifier of the WD and an input impedance of an antenna element of the WD;
processing circuitry in communication with the impedance matching circuitry and configured to:
determine WD contextual information, the WD contextual information including at least one of environmental information and hardware operating conditions of the WD;
determine at least one prediction of at least one of the antenna element input impedance, the power amplifier output impedance and a set of at least one control parameter of the impedance matching circuitry based at least in part on the WD contextual information; and
perform an adjustment to the impedance matching circuitry based at least in part on the at least one prediction.

13. The WD of claim 12, wherein the at least one prediction is obtained from a neural network trained to minimize a loss function, the loss function based at least in part on a difference between an expected value and a resultant value.

14. The WD of claim 13, wherein determining the at least one prediction includes determining a prediction expected to reduce an amount of power reflected backward from an input of the antenna element toward an output of the power amplifier.

15. The WD of claim 13, wherein determining the at least one prediction includes determining a prediction expected to increase an amount of power transferred by the impedance matching circuit from an output of the power amplifier to an input of the antenna element.

16. The WD of claim 13, wherein determining the at least one prediction includes determining a prediction expected to increase a gain of the power amplifier or to increase a power efficiency of the power amplifier.

17. (canceled)

18. The WD of claim 12, wherein the environmental information includes sensor information from embedded sensors configured to detect a relative position of the WD.

19. The WD of claim 18, wherein the relative position of the WD includes at least one of a position of fingers in proximity to the WD, a position of the WD with respect to a user's head, and a position of the WD relative to a material object.

20. The WD of claim 12, wherein the hardware operating conditions of the WD include at least one of a power amplifier temperature, backoff level, biasing level and impedances.

21. The WD of claim 12, wherein the at least one control parameter is based at least in part on a whether an impedance mismatch between the output impedance of the power amplifier and an input impedance of the antenna element exceeds a threshold.

22. The WD of claim 21, wherein the impedance mismatch is determined based at least in part on at least one of an impedance difference and a voltage standing wave ratio, VSWR.
